(19) United States
(12) Patent Application Publication
(10) Pub. No.: US 2017/0050456 A1
(43) Pub. Date: Feb. 23, 2017

(54) METHOD OF PRINTING

(71) Applicant: Océ-Technologies B.V., Venlo (NL)

(72) Inventors: Jeroen A. SCHELL, Venlo (NL); Guido G. WILLEMS, Venlo (NL)

(73) Assignee: Océ-Technologies B.V., Venlo (NL)

(21) Appl. No.: 15/345,019

(22) Filed: Nov. 7, 2016

Related U.S. Application Data
(63) Continuation of application No. PCT/EP2015/061701, filed on May 27, 2015.

(30) Foreign Application Priority Data
May 27, 2014 (EP) 14170087.2

(51) Int. Cl. B41M 5/00; B41J 11/00; C09D 11/03; C09D 11/033; C09D 11/322; B41J 2/01; C09D 11/107

(52) U.S. Cl. CPC B41M 5/0011; B41J 2/01; B41J 11/0015; B41M 5/0023; C09D 11/107; C09D 11/033; C09D 11/322; C09D 11/03; B41J 2202/03

(57) ABSTRACT

Disclosed is a method of printing having the steps of: providing a recording substrate having a water insoluble salt having a polyvalent cation; providing an aqueous ink composition having stably dispersed particles, the pH of the ink composition being between 2 and 5.5; printing the aqueous ink composition on the recording substrate. Optionally, the printing substrate is treated with a plasma prior to applying the ink composition. Optionally, the aqueous ink has a gelling agent, for instance, a water soluble salt of alginic acid.

### CROSS-REFERENCE TO RELATED APPLICATIONS

This application is a Continuation of PCT/EP2015/061701, filed May 27, 2015 and claims priority under 35 U.S.C. §119(a) to application Ser. No. 14/170,087.2, filed in Europe on May 27, 2014. The entire contents of these applications are herein explicitly incorporated by reference.

### FIELD OF THE INVENTION

The present invention relates to a method of printing with aqueous inks on porous and non porous print substrates with improved print quality.

### BACKGROUND ART

It is known from the prior art that print quality can be improved by introducing a pre-treatment liquid application step in a printing process. A pre-treatment liquid may comprise an aggregating agent that is capable of fixing the ink composition on the print substrate. Print artifacts such as feathering and inter color bleeding may thus be prevented or at least mitigated.

US2011/0187789 discloses an ink set comprising an ink composition and a treatment liquid comprising such an aggregating agent. The aggregating agent comprises an acid. The disclosed ink compositions comprise self-dispersing polymer particles and have a pH of around 8.5.

US2011/0227993 discloses a treatment liquid comprising an acidic compound, the treatment liquid having a pH of 0.5 to 2.0 at 25° C. The disclosed ink compositions comprise self-dispersing polymer particles and have a pH of around 8.5.

Treatment liquids comprising polyvalent metal salts are also known in the field, as is exemplified in US2011/0234690, WO2013/122601 and EP1577342.

It is a disadvantage of the printing methods disclosed in the prior art that an additional pre-treatment liquid application step is necessary to obtain the desired improvement of the print quality.

It is therefore an object of the present invention to provide simplified printing process enabling printing on a wide range of printing substrates with improved print quality

### SUMMARY OF THE INVENTION

This object is at least partly achieved by providing a method of printing comprising the steps of:
providing a recording substrate comprising a water insoluble salt comprising a polyvalent cation;
providing an aqueous ink composition comprising stably dispersed particles, wherein the ink composition has a pH of between 2 and 6, for instance, between 2 and 5.5;
printing the aqueous ink composition on the recording substrate.

The method is preferably performed with an ink set comprising at least two colored aqueous ink compositions comprising stably dispersed particles, wherein the ink compositions each have a pH of between 2 and 6. Print artifacts such as inter color bleeding can be reduced by this method.

The pH of the ink composition is preferably between 2.5 and 5.5, more preferably between 3 and 5, even more preferably between 3.5 and 4.5 and typically 4.

Without wanting to be bound to any theory, it is believed that the use of an acidic ink composition having a pH of between 2 and 6 liberates the polyvalent cations from the print substrate once the ink contacts the print substrate, such that a salt comprising the polyvalent cation which was originally present in the print substrate can act as an aggregating agent. The method according to the present invention therefore comprises an in-situ generation of an aggregating agent by printing the acidic ink composition.

US2002/0059883 discloses acidic ink compositions comprising carbon black disperse materials as pigment dispersions, which apparently are stable in acidic environment. Commercially available color pigments are however in general stabilized at higher pH (e.g. 7-9).

An additional disadvantage of ink compositions comprising dispersed polymer particles known from the prior art is that such ink compositions are not stable in an acidic environment. As disclosed above, such ink compositions are stable in an alkaline environment, i.e. at a pH of around 8.5.

The inventors have surprisingly found dispersed polymer particles and dispersed pigment particles suitable for use in ink compositions, in particular for ink jet applications, such that the produced ink compositions are stable in an acidic environment.

In an embodiment, the method according to the present invention comprises the additional step of treating a first surface of the recording substrate with a plasma prior to printing the aqueous ink composition on the recording substrate, wherein the aqueous ink composition is printed on the first surface of the recording substrate.

Water insoluble salts comprising a polyvalent cation present in the print substrate (e.g. CaCO₃) are often encapsulated by a (polymeric) dispersant or sizing agents and therefore not directly available on the surface of the print substrate. The plasma treatment in accordance with the this embodiment may be used to etch the surface of the printing substrate to remove the encapsulation of the water insoluble salt to obtain bare insoluble salt at the surface of the print substrate. Therefore, the plasma treatment may enhance the solubilization of water insoluble salts present in the print substrate by the acidic aqueous ink composition. The degree of enhancement can be regulated by the plasma dosage [Wmin/m²].

In an embodiment, the plasma treatment comprises a nitrogen plasma treatment.

In an embodiment, the first surface of the recording substrate is treated with a plasma power of between 10 Wmin/m² and 1000 Wmin/m², preferably between 20 Wmin/m² and 750 Wmin/m², more preferably between 50 Wmin/m² and 600 Wmin/m².

In an embodiment, the water insoluble salt present in the print substrate comprises a polyvalent metal ion, preferably an alkaline earth metal ion, more preferably selected from Mg²⁺ and Ca²⁺.

In an embodiment, the stably dispersed particles in the aqueous ink composition comprise dispersed resin particles and/or dispersed colorant particles.

In an embodiment the dispersed colorant particles are selected from the group consisting of particles of water insoluble dyes, water insoluble pigment particles and combinations thereof.

In an embodiment, the dispersed resin particles comprise alkali swellable resin particles and/or alkali soluble resin particles. An advantage of this embodiment is that alkali swellable resin particles and alkali soluble resin particles in general are stably dispersed at acidic conditions. Alkali soluble or swellable resin dispersions in general have a low viscosity at low pH and an increased viscosity at high pH (i.e. in an alkaline environment).

In an embodiment, the dispersed resin particles comprise acidic groups.

In an embodiment, the aqueous ink composition further comprises a gelling agent, the gelling agent having the property of gelling the aqueous ink composition when triggered by a cation, e.g. alginates. An advantage of this embodiment is that the gelling property of the ink composition may positively influence the spreading behavior on the print substrate and therefore the print quality. It may also provide more design freedom for ink compositions, which is in favor of tuning the ink properties as to satisfy multiple ink criteria.

In an embodiment, the gelling agent is present in a soluble form in the ink composition, wherein gelling occurs when the gelling agent is transformed in an insoluble form in the ink composition.

In an embodiment, the gelling agent comprises a salt that is soluble in the ink composition, wherein gelling occurs when ion exchange occurs, such that a salt is formed that is insoluble in the ink composition.

In an embodiment, the gelling agent is an ink soluble salt of an organic acid.

In an embodiment, the gelling agent is an ink soluble salt of alginic acid, preferably comprising Na⁺, K⁺ or NH₄⁺ as cation. Upon contact with the above described polyvalent metal ion, ion exchange occurs, such that less soluble or insoluble salts of alginic acid are formed and the ink composition starts to gel.

In an embodiment, the polyvalent metal ion that initiates gelling is preferably an alkaline earth metal ion, more preferably selected from Mg²⁺ and Ca²⁺.

In an embodiment, the water insoluble salt present in the print substrate comprises CaCO₃, and the aqueous ink composition comprises a pigment and alkaline swellable and/or soluble resin particles.

In an embodiment, the ink is printed with an inkjet printing device.

### BRIEF DESCRIPTION OF THE DRAWINGS

The present invention will become more fully understood from the detailed description given herein below and accompanying schematical drawings which are given by way of illustration only and are not limitative of the invention, and wherein:

FIG. 1 shows a schematic representation of an inkjet printing system.

FIG. 2 shows a graph representing the viscosity of an ink composition as used in the present invention as a function of pH.

FIG. 3 shows a graph representing the viscosity of an ink composition as used in the present invention as a function of the Calcium concentration in the ink.

FIG. 4 shows a graph representing the viscosity of an ink composition as used in the present invention on a printing substrate as a function of time.

FIG. 5 shows the rheological behavior of an ink composition as used in the present invention as a function of the concentration of alkali swellable/soluble resin particles.

FIG. 6A shows photographs of results of vertical flow tests of ink compositions.

FIG. 6B shows photographs of results of vertical flow tests of ink compositions, wherein the printing substrates were first plasma treated.

FIG. 7A shows photographs of results of vertical flow tests of ink compositions.

FIG. 7B shows photographs of results of vertical flow tests of ink compositions, wherein the printing substrates were first plasma treated.

FIG. 8 shows a graph representing the results of vertical flow tests of ink compositions as a function of plasma dosage.

### DETAILED DESCRIPTION

### Ink Composition

The aqueous ink composition may comprise stably dispersed particles, the pH of the ink composition being between 2 and 6. In one embodiment, an ink composition as used in a method according to the present invention comprises a water-dispersed polymer particles (latex), a water-dispersed colorant, water and optionally additives such as a cosolvent, a surfactant, a gelling agent and other additives. The components of the inks will be described in detail in the next sections.

### Water Dispersible Resin (Latex Resin)

The ink composition according to the present invention contains a water-dispersible resin in view of the pigment fixability to recording media. As the water-dispersible resin, a water-dispersible resin excellent in film formability (image formability) and having high water repellency, high water fastness, and high weatherability is useful in recording images having high water fastness and high image density (high color developing ability).

Examples of the water-dispersible resin include synthetic resins and natural polymer compounds.

Examples of the synthetic resins include polyester resins, polyurethane resins, polyepoxy resins, polyamide resins, polyether resins, poly(meth)acrylic resins, acryl-silicone resins, fluorine-based resins, polyolefin resins, polystyrene-based resins, polybutadiene-based resins, polyvinyl acetate-based resins, polyvinyl alcohol-based resins, polyvinyl ester-based resins, polyvinyl chloride-based resins, polyacrylic acid-based resins, unsaturated carboxylic acid-based resins and copolymers, such as styrene-acrylate copolymer resins, and styrene-butadiene copolymer resins.

Examples of the natural polymer compounds include celluloses, rosins, and natural rubbers.

As the fluorine-based resin, fluorine-based resin fine particles having a fluoroolefin unit are preferred. Of these, fluorine-containing resin fine particles containing a fluoroolefin unit and a vinylether unit are particularly preferable. The fluoroolefin unit is not particularly limited and may be suitably selected in accordance with the intended use. Examples thereof include —CF₂CF₂—, —CF₂CF(CF₃)—, and —CF₂CFCl—.

The vinylether unit is not particularly limited and may be suitably selected in accordance with the intended use. Examples thereof include —C(Rₐ)HC(OR_{b})—; wherein Rₐ is a hydrogen atom or a methyl group; and wherein R_{b} may be selected from the group consisting of —CH₂R_{c}, —C₃H₆R_{c}, —C₄H₈R_{c} and —C₅H₁₀R_{c}, wherein R_{c} is selected from the group consisting of a hydrogen atom (—H), an hydroxy group (—OH) or a carboxylic acid group (—COOH).

As the fluorine-containing vinylether-based resin fine particles containing a fluoroolefin unit and a vinylether unit, an alternated copolymer, in which the fluoroolefin unit and the vinylether unit are alternately copolymerized, is preferable. As such a fluorine-based resin fine particles, a suitably synthesized compound may be used and a commercially available product may be used.

The water-dispersible resin may be used in the form of a homopolymer, a copolymer or a composite resin, and all of water-dispersible resins having a monophase structure or core-shell structure and those prepared by power-feed emulsion polymerization may be used.

As the water-dispersible resin, it is possible to use a resin which in itself has a hydrophilic group and hence has a certain degree of self-dispersibility, and a resin which in itself has no dispersibility but to which the dispersibility is imparted with use of a surfactant and/or another resin having a hydrophilic group. Among these resins, an emulsion of a resin obtained by emulsion polymerization or suspension polymerization of an ionomer of a polyester resin or a polyurethane resin is most suitably used. In the case of emulsion polymerization of an unsaturated monomer, a resin dispersion is obtained by initiating a polymerization reaction in the dispersed monomer phase in the monomer in water emulsion. A polymerization initiator, a surfactant, a chain transfer agent, a chelating agent and a pH adjustor may be added to the monomer in water emulsion. Thus, a water-dispersed resin can be easily obtained, and the desired properties are easily obtained because the resin components can be varied.

As the unsaturated monomer, unsaturated carboxylic acids, monofunctional or polyfunctional (meth)acrylic acid ester monomers, (meth)acrylic acid amide monomers, aromatic vinyl monomers, vinyl cyano compound monomers, vinyl monomers, allyl compound monomers, olefin monomers, diene monomers, and oligomers having unsaturated carbons may be used alone or in combination. By combining these monomers, properties or the resulting resin can be flexibly modified. The properties of the resulting resin can also be modified with use of an oligomer type polymerization initiator, through a polymerization reaction or graft reaction.

Examples of the unsaturated carboxylic acids include acrylic acids, methacrylic acid, itaconic acids, fumaric acids, and maleic acids.

Examples of the monofunctional (meth)acrylic acid ester monomers include methyl methacrylate, ethyl methacrylate, isopropyl methacrylate, n-butyl methacrylate, isobutyl methacrylate, n-amyl methacrylate, isoamyl methacrylate, n-hexyl methacrylate, 2-ethylhexyl methacrylate, octyl methacrylate, decyl methacrylate, dodecyl methacrylate, octadecyl methacrylate, cyclohexyl methacrylate, phenyl methacrylate, benzyl methacrylate, glycidyl methacrylate, 2-hydroxyethyl methacrylate, 2-hydroxpropyl methacrylate, dimethylaminoethyl methacrylate, methacryloxyethyltrimethyl ammonium salt, 3-methacryloxypropyl trimethoxysilane, methyl acrylate, ethyl acrylate, isopropyl acrylate, n-butyl acrylate, isobutyl acrylate, n-amyl acrylate, isoamyl acrylate, n-hexyl acrylate, 2-ethylhexyl acrylate, octyl acrylate, decyl acrylate, dodecyl acrylate, octadecyl acrylate, cyclohexyl acrylate, phenyl acrylate, benzyl acrylate, glycidyl acrylate, 2-hydroxyethyl acrylate, 2-hydroxpropyl acrylate, dimethylaminoethyl acrylate, and acryloxyethyltrimethoxy ammonium salt.

Examples of the polyfunctional (meth)acrylic acid monomers include ethylene glycol dimethacrylate, diethylene glycol dimethacrylate, triethylene glycol dimethacrylate, polyethylene glycol dimethacrylate, 1, 3-butylene glycol dimethacrylate, 1,4-butylene glycol dimethacrylate, 1,6-hexanediol dimethacrylate, neopentyl glycol dimethacrylate, dipropylene glycol dimethacrylate, polypropylene glycol dimethacrylate, polybutylene glycol dimethacrylate, 2,2-bis(4-methacryloxydiethoxyphenyl)propane, trimethylolpropane trimethacrylate, trimethylolethane trimethacrylate, polyethylene glycol diacrylate, triethylene glycol diacrylate, 1,3-butylene glycol diacrylate, 1,4-butylene glycol diacrylate, 1,6-hexanediol diacrylate, neopentyl glycol diacrylate, 1,9-nonanediol diacrylate, polypropylene glycol diacrylate, 2,2-bis(4-acryloxypropyloxyphenyl)propane, 2,2-bis(4-acryloxydiethoxyphenyl)propane, trimethylolpropane triacrylate, trimethylolethane triacrylate, tetramethylolmethane triacrylate, ditrimethylol tetraacrylate, tetramethylolmethane tetraacrylate, pentaerythritol tetraacrylate, and dipentaerythritol hexaacrylate.

Examples of the (meth)acrylic acid amide monomers include acrylamide, methacrylamide, N,N-dimethyacrylamide, methylene-bis-acrylamide, and 2-acrylamide-2-methylpropane sulfonic acid. Examples of the aromatic vinyl monomers include styrene, α-methylstyrene, vinyltoluene, 4-t-butylstyrene, chlorostyrene, vinylanisole, vinylnaphthalene, and divinylbenzene.

Examples of the vinyl cyano compound monomers include acrylonitrile, and methacrylonitrile.

Examples of the vinyl monomers include vinyl acetate, vinylidene chloride, vinyl ether, vinyl ketone, vinylpyrrolidone, vinyl sulfonic acid or salts thereof, vinyltrimethoxysilane, and vinyltriethoxysilane.

Examples of the allyl compound monomers include allylsulfonic acid or salts thereof, allylamine, allyl chloride, diallylamine, and diallyldimethylammonium salts.

Examples of the olefin monomers include ethylene, and propylene. Examples of the diene monomers include butadiene, and chloroprene.

Examples of the oligomers having unsaturated carbon atoms include styrene oligomers having methacryloyl groups, styrene-acrylonitrile oligomer having methacryloyl groups, methyl methacrylate oligomers having methacryloyl groups, dimethyl siloxane oligomers having methacryloyl groups, and polyester oligomers having acryloyl groups.

The water-dispersible resin preferably has a function to fix the water-dispersible colorant on the surface of paper, to form a coat at normal temperature and to improve fixability of coloring material. Therefore, the minimum film forming temperature (MFT) of the water-dispersible resin is preferably 60° C. or lower, more preferably 45° C. or lower, even more preferably 30° C. or lower. Alternatively, water dispersible resins having a higher MFT, typically up to 100° C. may be used in combination with a plasticizing cosolvent in order to lower the MFT of the latex composition. Further, if the glass transition temperature of the water-dispersible resin is −40° C. or lower, tucks may occur in printed matters because of the increased viscidity of the resin coat. Thus, the water-dispersible resin preferably has a glass transition temperature of −30° C. or higher.

The content of the water-dispersible resin added in the ink of the present invention is preferably from 1-40 weight % based on the total weight of the ink, and it is more preferably from 1.5-30 weight %, and it is still more preferably from 2-25 weight %. Even more preferably, the amount of the water-dispersible resin contained in the inkjet ink, as a solid content, is 2.5 weight % to 15 weight %, and more preferably 3 weight % to 7 weight %, relative to the total ink composition.

The average particle diameter (D50) of the water-dispersible resin is preferably from 10 nm-1 μm, it is more preferably from 10-500 nm, and it is still more preferably from 20-200 nm, and especially preferably it is from 50-200 nm.

When the average particle diameter (D50) is equal to or less than 10 nm, significant effects in improving the image quality or enhancing transfer characteristics of the image cannot be fully expected, even if aggregation occurs.

The average particle diameter (D50) of the water-dispersible resin is relevant to the viscosity of the dispersion liquid. In the case of water-dispersible resins having the same composition, the smaller the particle diameter, the higher is the viscosity at the same solid content. The average particle diameter (D50) of the water-dispersible resin is preferably 50 nm or greater to prevent the resulting ink from having excessively high viscosity.

When the average particle diameter (D50) is equal to or greater than 1 μm, there may be a possibility that the ejection characteristics of the ink from the inkjet head or the storage stability of the ink will be deteriorated. In order not to impair the ink ejection stability, the average particle diameter (D50) of the water-dispersible resin is preferably 200 nm or smaller, and more preferably 150 nm or smaller.

In addition, there are no specific restrictions to the particle size distribution of the polymer particles, and it is possible that the polymer particles have a broad particle size distribution or the polymer particles have a particle size distribution of monodisperse type.

In an embodiment, the ink composition according to the present invention comprises two or more water-dispersible resins selected from the above cited synthetic resins, synthetic copolymer resins and natural polymer compounds in admixture with each other.

Commercially available resin dispersions (latices), suitable for use in the present invention are not particularly limited to any kind, as long as the resin particles are stably dispersed in acidic environment, e.g. stable dispersion in a pH range of between 2 and 6. Examples of such commercially available latices are (but not limited to): Lubrizol Carboset® GA2363E, Solthix A100, A200, A300; DSM Neocryl® series: BT-107s, BT-106, BT-101, BT-24, BT-21, BT-9, XK-39, and XK-52.

### Water-Dispersible Colorant

A water-dispersed colorant may be a pigment or a mixture of pigments, a dye or a mixture of dyes or a mixture comprising pigments and dyes, as long as the colorant is water-dispersible and stably dispersed in an acidic environment, e.g. in a pH range of between 2 and 6.

In the inkjet ink according to the present invention, a pigment is primarily used as a water-dispersible colorant in view of the weatherability, and, for the purpose of controlling color tone, a dye may be contained within the range not impairing the weatherability. The pigment is not particularly limited and may be suitably selected in accordance with the intended use.

Examples of the pigment usable in the present invention include those commonly known without any limitation, and either a water-dispersible pigment or an oil-dispersible pigment is usable. For example, an organic pigment such as an insoluble pigment or a lake pigment, as well as an inorganic pigment such as carbon black, is preferably usable.

Examples of the insoluble pigments are not particularly limited, but preferred are an azo, azomethine, methine, diphenylmethane, triphenylmethane, quinacridone, anthraquinone, perylene, indigo, quinophthalone, isoindolinone, isoindoline, azine, oxazine, thiazine, dioxazine, thiazole, phthalocyanine, or diketopyrrolopyrrole dye.

For example, inorganic pigments and organic pigments for black and color inks are exemplified. These pigments may be used alone or in combination.

As the inorganic pigments, it is possible to use carbon blacks produced by a known method such as a contact method, furnace method and thermal method, in addition to titanium oxide, iron oxide, calcium carbonate, barium sulfate, aluminum hydroxide, barium yellow, cadmium red and chrome yellow.

As the organic pigments, it is possible to use azo pigments (including azo lake, insoluble azo pigments, condensed pigments, chelate azo pigments and the like), polycyclic pigments (e.g., phthalocyanine pigments, perylene pigments, perynone pigments, anthraquinone pigments, quinacridone pigments, dioxazine pigments, indigo pigments, thioindigo pigments, isoindolinone pigments, and quinophthalone pigments), dye chelates (e.g., basic dye type chelates, and acidic dye type chelates), nitro pigments, nitroso pigments, aniline black. Among these, particularly, pigments having high affinity with water are preferably used.

Specific pigments which are preferably usable are listed below.

Examples of pigments for magenta or red include: C.I. Pigment Red 1, C.I. Pigment Red 2, C.I. Pigment Red 3, C.I. Pigment Red 5, C.I. Pigment Red 6, C.I. Pigment Red 7, C.I. Pigment Red 15, C.I. Pigment Red 16, C.I. Pigment Red 17, C.I. Pigment Red 22, C.I. Pigment Red 23, C.I. Pigment Red 31, C.I. Pigment Red 38, C.I. Pigment Red 48:1, C.I. Pigment Red 48:2 (Permanent Red 2B(Ca)), C.I. Pigment Red 48:3, C.I. Pigment Red 48:4, C.I. Pigment Red 49:1, C.I. Pigment Red 52:2; C.I. Pigment Red 53:1, C.I. Pigment Red 57:1 (Brilliant Carmine 6B), C.I. Pigment Red 60:1, C.I. Pigment Red 63:1, C.I. Pigment Red 64:1, C.I. Pigment Red 81. C.I. Pigment Red 83, C.I. Pigment Red 88, C.I. Pigment Red 101 (colcothar), C.I. Pigment Red 104, C.I. Pigment Red 106, C.I. Pigment Red 108 (Cadmium Red), C.I. Pigment Red 112, C.I. Pigment Red 114, C.I. Pigment Red 122 (Quinacridone Magenta), C.I. Pigment Red 123, C.I. Pigment Red 139, C.I. Pigment Red 44, C.I. Pigment Red 146, C.I. Pigment Red 149, C.I. Pigment Red 166, C.I. Pigment Red 168, C.I. Pigment Red 170, C.I. Pigment Red 172, C.I. Pigment Red 177, C.I. Pigment Red 178, C.I. Pigment Red 179, C.I. Pigment Red 185, C.I. Pigment Red 190, C.I. Pigment Red 193, C.I. Pigment Red 209, C.I. Pigment Red 219 and C.I. Pigment Red 222, C.I. Pigment Violet 1 (Rhodamine Lake), C.I. Pigment Violet 3, C.I. Pigment Violet 5:1, C.I. Pigment Violet 16, C.I. Pigment Violet 19, C.I. Pigment Violet 23 and C.I. Pigment Violet 38.

Examples of pigments for orange or yellow include: C.I. Pigment Yellow 1, C.I. Pigment Yellow 3, C.I. Pigment Yellow 12, C.I. Pigment Yellow 13, C.I. Pigment Yellow 14, C.I. Pigment Yellow 15, C.I. Pigment Yellow 15:3, C.I. Pigment Yellow 17, C.I. Pigment Yellow 24, C.I. Pigment Yellow 34, C.I. Pigment Yellow 35, C.I. Pigment Yellow 37, C.I. Pigment Yellow 42 (yellow iron oxides), C.I. Pigment Yellow 53, C.I. Pigment Yellow 55, C.I. Pigment Yellow 74, C.I. Pigment Yellow 81, C.I. Pigment Yellow 83, C.I. Pigment Yellow 93, C.I. Pigment Yellow 94, C.I. Pigment Yellow 95, C.I. Pigment Yellow 97, C.I. Pigment Yellow 98, C.I. Pigment Yellow 100, C.I. Pigment Yellow 101, C.I. Pigment Yellow 104, C.I. Pigment Yellow 408, C.I. Pigment Yellow 109, C.I. Pigment Yellow 110, C.I. Pigment Yellow 117, C.I. Pigment Yellow 120, C.I. Pigment Yellow 128, C.I. Pigment Yellow 138, C.I. Pigment Yellow 150, C.I. Pigment Yellow 151, C.I. Pigment Yellow 153 and C.I. Pigment Yellow 183; C.I. Pigment Orange 5, C.I. Pigment Orange 13, C.I. Pigment Orange 16, C.I. Pigment Orange 17, C.I. Pigment Orange 31, C.I. Pigment Orange 34, C.I. Pigment Orange 36, C.I. Pigment Orange 43, and C.I. Pigment Orange 51.

Examples of pigments for green or cyan include: C.I. Pigment Blue 1, C.I. Pigment Blue 2, C.I. Pigment Blue 15, C.I. Pigment Blue 15:1, C.I. Pigment Blue 15:2, C.I. Pigment Blue 15:3 (Phthalocyanine Blue), C.I. Pigment Blue 16, C.I. Pigment Blue 17:1, C.I. Pigment Blue 56, C.I. Pigment Blue 60, C.I. Pigment Blue 63, C.I. Pigment Green 1, C.I. Pigment Green 4, C.I. Pigment Green 7, C.I. Pigment Green 8, C.I. Pigment Green 10, C.I. Pigment Green 17, C.I. Pigment Green 18 and C.I. Pigment Green 36.

In addition to the above pigments, when red, green, blue or intermediate colors are required, it is preferable that the following pigments are employed individually or in combination thereof. Examples of employable pigments include: C.I. Pigment Red 209, 224, 177, and 194, C.I. Pigment Orange 43, C.I. Vat Violet 3, C.I. Pigment Violet 19, 23, and 37, C.I. Pigment Green 36, and 7, C.I. Pigment Blue 15:6.

Further, examples of pigments for black include: C.I. Pigment Black 1, C.I. Pigment Black 6, C.I. Pigment Black 7 and C.I. Pigment Black 11. Specific examples of pigments for black color ink usable in the present invention include carbon blacks (e.g., furnace black, lamp black, acetylene black, and channel black); (C.I. Pigment Black 7) or metal-based pigments (e.g., copper, iron (C.I. Pigment Black 11), and titanium oxide; and organic pigments (e.g., aniline black (C.I. Pigment Black 1).

In an embodiment, the colorant contains a polymer emulsion in which a water-insoluble or sparsely soluble coloring material is coated with an anionic polymer resin. As the water-dispersible pigment according to this embodiment, a polymer emulsion obtained by coating a pigment with an anionic polymer resin is preferably used. The polymer emulsion obtained by coating a pigment with an anionic polymer resin is an emulsion in which a pigment is encapsulated by an anionic polymer resin coating layer, also termed core-and-shell dispersible pigments. Alternatively, a pigment may be adsorbed on the surface of a polymer resin dispersed particle. Examples of suitable anionic polymer resins for use in this embodiment include vinyl polymers, polyester polymers, and polyurethane polymers. For example, the anionic polymers disclosed in Japanese Patent Application Laid-Open (JP-A) Nos. 2000-53897 and 2001-139849 can be used.

The average particle diameter (D50) of the water-dispersible pigment is preferably from 0.01 μm (10 nm) to 0.25 μm (250 nm), more preferably from 20 nm to 200 nm, and it is still more preferably from 40 nm to 150 nm in the inkjet ink in view of the dispersion stability and ejection reliability.

The amount of the water-insoluble pigment contained in the inkjet ink, as a solid content, is preferably 0.5 weight % to 15 weight %, more preferably 0.8 weight % to 10 weight %, and even more preferably between 1 weight % and 6 weight %. When the amount of the water-insoluble pigment is less than 0.5 weight %, the color developing ability and image density of the ink may degrade. When it is more than 15 weight %, unfavorably, the viscosity of the ink is increased, causing a degradation in ink ejection stability.

### Solvent

Water is cited as an environmentally friendly and hence desirable solvent. In the present invention, the content of water to the whole ink is preferably from 20 weight % to 80 weight %. It is more preferable that the content of water is from 30 weight % to 75 weight %, even more preferable from 40 weight % to 70 weight %.

### Cosolvent

As a solvent of the ink, for the purposes of improving the ejection property of the ink or adjusting the ink physical properties, the ink preferably contains a water soluble organic solvent in addition to water. As long as the effect of the present invention is not damaged, there is no restriction in particular in the type of the water soluble organic solvent.

Examples of the water-soluble organic solvent include polyhydric alcohols, polyhydric alcohol alkyl ethers, polyhydric alcohol aryl ethers, nitrogen-containing heterocyclic compounds, amides, amines, ammonium compounds, sulfur-containing compounds, propylene carbonate, and ethylene carbonate.

Examples of the solvent include: glycerin (also termed glycerol), propylene glycol, dipropylene glycol, tripropylene glycol, tetrapropylene glycol, polypropylene glycol, ethylene glycol, diethylene glycol, triethylene glycol, tetraethylene glycol, polyethylene glycols preferably having a molecular weight of between 200 gram/mol and 1000 gram/mol (e.g. PEG 200, PEG 400, PEG 600, PEG 800, PEG 1000), glycerol ethoxylate, petaerythritol ethoxylate, polyethylene glycol (di)methylethers preferably having a molecular weight of between 200 gram/mol and 1000 gram/mol, tri-methylol-propane, diglycerol (diglycerin), trimethylglycine (betaine), N-methylmorpholine N-oxide, decaglyserol, 1,4-butanediol, 1,3-butanediol, 1,2,6-hexanetriol, 2-pyrrolidinone, dimethylimidazolidinone, ethylene glycol mono-butyl ether, diethylene glycol monomethyl ether, diethylene glycol monoethyl ether, diethylene glycol mono-propyl ether, diethylene glycol mono-butyl ether, triethylene glycol monomethyl ether, triethylene glycol monoethyl ether, triethylene glycol mono-propyl ether, triethylene glycol mono-butyl ether, tetraethylene glycol monomethyl ether, tetraethylene glycol monoethyl ether, propylene glycol mono-butyl ether, dipropylene glycol monomethyl ether, dipropylene glycol monoethyl ether, dipropylene glycol monopropyl ether, diethylene glycol monobutyl ether, tripropylene glycol monomethyl ether, tripropylene glycol monoethyl ether, tripropylene glycol monopropyl ether, tripropylene glycol monobutyl ether, tetrapropylene glycol monomethyl ether, diethylene glycol diethyl ether, diethylene glycol dibutyl ether, triethylene glycol diethyl ether, triethylene glycol dibutyl ether, dipropylene glycol dibutyl ether, tri propylene glycol dibutyl ether, 3-methyl 2,4-pentanediol, diethylene-glycol-monoethyl ether acetate, 1,2-hexanediol, 1,2-pentanediol and 1,2-butanediol.

Examples of the sulfur-containing compounds include dimethylsulfoxide (bp 139° C.), sulfolane (bp 285° C.), and thiodiglycol (bp 282° C.).

As other solid water-soluble organic solvents, saccharides are preferable. Examples of the saccharides include monosaccharides, disaccharides, oligosaccharides (including trisaccharides and tetrasaccharide), and polysaccharides.

Specific examples thereof include glucose, mannose, fructose, ribose, xylose, arabinose, galactose, maltose, cellobiose, lactose, sucrose, trehalose, and maltotriose. Here, the above-mentioned polysaccharides mean broad sense-saccharides, which may include substances existing widely in nature, such as orcyclodextrin and cellulose. Derivatives of these saccharides include reducing sugars of saccharides (for example, sugar alcohol, which is expressed by the general formula: HOCH₂(CHOH)ₙCH₂OH, wherein n is an integer of 2 to 5), oxidized sugars (for example, aldonic acids and uronic acids), amino acids, and thio acids. Among these, sugar alcohol is preferable. Specific examples of sugar alcohol include maltitol and sorbitol.

In an embodiment, a mixture of the water-soluble organic solvents may be comprised in an ink composition according to the present invention. The individual organic solvents preferably being present in an amount of 1 weight % to 50 weight %, more preferably in an amount of 1 weight % to 40 weight %, even more preferably in an amount of 1 weight % to 25 weight %, relative to the total ink composition.

In an embodiment, the ink composition comprises at least one oligomeric or polymeric cosolvent, in particular at least one selected from the group consisting of polyethylene glycols and polyethylene glycol (di)methyl ethers as defined above. An additional advantage of such cosolvents is that they provide a viscosity increase to printed ink drops upon drying (due to evaporation of water). Such a viscosity increase prevents a spreading ink drop from coalescing with neighboring ink drops.

Print artifacts such as puddling and dewetting are prevented or at least mitigated by using such oligomeric and/or polymeric cosolvents in the ink composition. An additional advantage of this embodiment is that media curling is effectively reduced.

Oligomeric and polymeric cosolvents are preferably present in an amount of between 0 weight % and 30 weight %, more preferably between 2 weight % and 27 weight % and even more preferably between 5 weight % and 25 weight %.

The total amount of the water-soluble organic solvent contained in the ink composition is not particularly limited. It is, however, preferably 0 weight % to 75 weight %, and more preferably 10 weight % to 70 weight %, and even more preferably 15 weight % to 60 weight % with respect to the total ink composition. When the amount of the water-soluble organic solvent is more than 80 weight %, the drying times of the ink compositions are too long. When the amount is less than 10 weight %, water in the ink compositions may evaporate more quickly, which may significantly reduce the stability of the ink composition.

A mass ratio of the water-dispersible colorant to the water-soluble organic solvent in the inkjet ink affects the ejection stability of ink ejected from an inkjet head. For example, when the addition amount of the water-soluble organic solvent is low regardless of high solid content of the water-dispersible colorant, evaporation of water near the ink meniscus of nozzles proceeds, and ejection defects may be caused. The total amount of the water-soluble organic solvent contained in the inkjet ink is preferably 20 weight % to 50 weight %, and more preferably 20 weight % to 45 weight %. When amount of the water-soluble organic solvent is less than 20 weight %, the ejection stability may degrade and waste ink may adhere to instruments used to maintain the ink ejection apparatus. In contrast, when the amount of the water-soluble organic solvent is more than 50 weight %, the dryness of ink printed on paper may degrade, and further the quality of characters printed on regular paper may degrade.

### Surfactants

It is preferable that the ink of the present invention contains a surfactant in order to improve an ink ejection property and/or the wettability of the surface of a recording medium, and the image density and color saturation of the image formed and reducing white spots therein. To improve the spreading of the ink on the surface of recording medium and to reduce puddling, it is preferable to adjust the dynamic surface tension (measured at 10 Hz) of the ink composition to 35 mN/m or lower, preferably to 34 mN/m or lower, more preferably to 33 mN/m or lower, even more preferably to 32 mN/m or lower by the surfactant. The static surface tension of the ink composition is preferably below 30 mN/m (measured at 0.1 Hz).

Examples of surfactants are not specifically limited. The following can be cited.

Examples of the surfactant include nonionic surfactants, cationic surfactants, anionic surfactants, amphoteric surfactants, in particular betaine surfactants, silicone surfactants, and fluorochemical surfactants. Particularly, at least one selected from acetylene surfactants, silicone surfactants and fluorochemical surfactants capable of reducing the surface tension to 30 mN/m or lower is preferably used.

Examples of a cationic surfactant include: aliphatic amine salts, aliphatic quarternary ammonium salts, benzalkonium salts, benzethonium chloride, pyridinium salts, imidazolinium salts.

Examples of an anionic surfactant include: polyoxyethylene alkylether acetic acid salts, dodecylbenzene sulfonic acid salts, lauric acid salts, and salts of polyoxyethylene alkylether sulfate, an aliphatic acid soap, an N-acyl-N-methyl glycin salt, an N-acyl-N-methyl-β-alanine salt, an N-acylglutamate, an acylated peptide, an alkylsulfonic acid salt, an alkylbezenesulfonic acid salt, an alkylnaphthalenesulfonic acid salt, a dialkylsulfo succinate (e.g. sodium dioctyl sulfosuccinate (DSS); alternative names: docusate sodium, Aerosol OT and AOT), alkylsulfo acetate, α-olefin sulfonate, N-acyl-methyl taurine, a sulfonated oil, a higher alcohol sulfate salt, a secondary higher alcohol sulfate salt, an alkyl ether sulfate, a secondary higher alcohol ethoxysulfate, a polyoxyethylene alkylphenyl ether sulfate, a monoglysulfate, an aliphatic acid alkylolamido sulfate salt, an alkyl ether phosphate salt and an alkyl phosphate salt.

Examples of an amphoteric surfactant include: a carboxybetaine type, a sulfobetaine type, an aminocarboxylate salt and an imidazolium betaine.

Examples of a nonionic surfactant include: polyoxyethylene alkylether, polyoxypropylene polyoxyethylene alkylether, a polyoxyethylene secondary alcohol ether, a polyoxyethylene alkylphenyl ether, a polyoxyethylene sterol ether, a polyoxyethylenelanolin derivative polyoxyethylene polyoxypropylene alkyl ether, polyoxyethylene alkylester, a polyoxyethyleneglycerine aliphatic acid ester, a polyoxyethylene castor oil, a hydrogenated castor oil, a polyoxyethylene sorbitol aliphatic acid ester, a polyethylene glycols aliphatic acid ester, an aliphatic acid monoglyceride, a polyglycerine aliphatic acid ester, a sorbitan aliphatic acid ester, polyoxyethylene sorbitan aliphatic ester, a propylene glycol aliphatic acid ester, a cane sugar aliphatic acid ester, an aliphatic acid alkanol amide, polyoxyethylene alkylamide, a polyoxyethylene aliphatic acid amide, a polyoxyethylene alkylamine, an alkylamine oxide, an acetyleneglycol, an ethoxylated acetylene glycol, acetylene alcohol.

Specific examples of ethoxylated acetylene glycols are ethoxylated 3-methyl-1-nonyn-3-ol, ethoxylated 7,10-dimethyl-8-hexadecyne-7,10-diol, ethoxylated 4,7-dimethyl-5-decyne-4,7-diol, ethoxylated 2,4,7,9-tetramethyl-5-decyne-4,7-diol, and ethoxylated 2,5,8,11-tetramethyl-6-dodecyne-5,8-diol. These can be used in combination with each other.

It is preferable that a part of these surfactants is furthermore substituted with a fluorine atom or a silicon atom from a viewpoint of reducing the surface tension.

As the fluorochemical surfactant, a surfactant having 2 to 16 fluorine-substituted carbon atoms is preferred, and a surfactant having 4 to 16 fluorine-substituted carbon atoms is more preferred. When the number of fluorine-substituted carbon atoms is less than 2, the effect peculiar to a fluorochemical surfactant may not be obtained. When it is more than 16, degradation in storage stability etc. may arise.

Examples of the fluorochemical surfactants include nonionic fluorochemical surfactants, anionic fluorochemical surfactants, and amphoteric fluorochemical surfactants.

Examples of the nonionic fluorochemical surfactants include perfluoroalkyl phosphoric acid ester compounds, perfluoroalkyl ethylene oxide adducts, and polyoxyalkylene ether polymer compounds having perfluoroalkyl ether groups as side chains. Among these, polyoxyalkylene ether polymer compounds having perfluoroalkyl ether groups as side chains are preferable because they are low in foaming property.

As the fluorochemical surfactants, commercially available products may be used. Examples of the commercially available products include SURFLON S-HI, S-112, S-113. S-121, S-131, S-132, S-141 and S-145 (all of which are produced by Asahi Glass Co., Ltd.), FLUORAD FC-93, FC-95, FC-98, FC-129, FC-135, FC-170C, FC-430 and FC-431 (all of which are produced by Sumitomo 3M Limited), MEGAFAC F-470, F-1405 and F-474 (all of which are produced by Dainippon Ink Chemical Industries Co., Ltd.), ZONYL TBS, FSP, FSA, FSN-100, FSN, FSO-100, FSO, FS-300 and UR (all of which are produced by E. I. du Pont de Nemours and Company), FT-110, FT-250, FT-251, FT-400S, FT-150 and FT-400SW (all of which are produced by Neos Company Limited), and POLYFOX PF-136A, PF-156A, PF-151N, PF-154, and PF-159 (all of which are produced by OMNOVA Solutions Inc.). Among these, ZONYL FS-300 (produced by E. I. du Pont de Nemours and Company), FT-110, FT-250, FT-251, FT-400S, FT-150, FT-400SW (produced by Neos Company Limited), and POLYFOX PF-151N (produced by OMNOVA Solutions Inc.) are preferable in that they are excellent in print quality, particularly in color developing ability and in dye-leveling property.

The silicone surfactant is not particularly limited and may be suitably selected in accordance with the intended use.

Examples of the silicone surfactant include side-chain-modified polydimethylsiloxane, both-ends-modified polydimethylsiloxane, one-end-modified polydimethylsiloxane, and side-chain/both-ends-modified polydimethylsiloxane. Polyether-modified silicone surfactants having, as a modified group, a polyoxyethylene group or a polyoxyethylene polyoxypropylene group are particularly preferable because they exhibit excellent physical properties as water-based surfactants.

The silicone surfactant may be suitably synthesized or commercial products may be used. The commercial product is readily available from BYK Chemie GmbH, Shin-Etsu Chemical Co., Ltd., TORAY Dow Corning Silicone Co., Ltd., Nihon Emulsion Co., Ltd., Kyoeisha Chemical Co., Ltd., or the like.

The polyether-modified silicone surfactant is not particularly limited and may be suitably selected in accordance with the intended use.

As the polyether-modified silicone surfactant, commercial products may be used. Examples of the commercial products include KF-618, KF-642 and KF-643 (produced by Shin-Etsu Chemical Co., Ltd.); EMALEX-SS-5602 and SS-1906EX (produced by Nihon Emulsion Co., Ltd.); FZ-2105, FZ-2118, FZ-2154, FZ-2161, FZ-2162, FZ-2163 and FZ-2164 (produced by TORAY Dow Corning Silicone Co., Ltd.); and BYK-33, BYK 331, BYK 341, BYK 348, BYK 349, BYK 3455, BYK-387 (produced by BYK Chemie GmbH); Tegowet 240, Tegowet 245, Tegowet 250, Tegowet 260 (produced by Evonik); Silwet L-77 (produced by Sabic).

All surfactants mentioned in this section may be used solely, or they may be used in combination of the plural.

The total amount of the surfactant contained in the inkjet ink is preferably 0.01 weight % to 3.0 weight %, and more preferably 0.5 weight % to 2 weight %, with respect to the total ink composition. When the amount of the surfactant is less than 0.01 weight %, the effect of adding the surfactant may be substantially reduced or even insignificant. When it is more than 3.0 weight %, the permeability to recording media may be higher than necessary, possibly causing a degradation of image density and occurrence of ink-strikethrough.

### Gelling Agent

An ink compositions according to or as used in the present invention may comprise a gelling agent, the gelling agent having the property of gelling the aqueous ink composition when triggered by a cation.

Examples of such gelling agents are (but not limited to): alginates.

The ink composition comprises a gelling agent in soluble form, e.g. Na⁺, K⁺, NH₄⁺ alginate salts. When contacted with a water insoluble salt comprising a polyvalent cation, ion exchange may occur, such that a water insoluble alginate salt is formed (e.g. Ca²⁺-alginate and the ink composition starts gelling).

### Receiving Media

Suitable receiving media for use in a printing process using an ink or set of inks (Cyan, Magenta, Yellow and blacK, CMYK) according to the present invention are not particularly limited to any type, as long as the receiving medium comprises a water insoluble salt, preferably comprising a polyvalent cation. The receiving medium may be suitably selected depending on the intended application.

Suitable receiving media may range from strongly water absorbing media such as plain paper (for example Océ Red Label) to non-water-absorbing media such as plastic sheets (for example PE, PP, PVC and PET films). To optimize print quality, inkjet coated media are known, which media comprise a highly water absorbing coating.

Of particular interest in the context of the present invention are Machine Coated (MC) media (also known as offset coated media) and glossy (coated) media. MC media are designed for use in conventional printing processes, for example offset printing and show good absorption characteristics with respect to solvents used in inks used in such printing processes, which are usually organic solvents. MC and glossy media show inferior absorption behavior with respect to water (worse than plain paper, better than plastic sheets), and hence aqueous inks.

Machine coated or offset coated media comprise a base layer and a coating layer.

The base layer may be a sheet of paper mainly made of wood fibers or a non-woven fabric material comprising wood fibers combined with synthetic fibers. The base layer may be made of wood pulp or recycled paper pulp and may be bleached.

As an internal filler for the base, a conventional white pigment may be used. For example, the following substances may be used as a white pigment: an inorganic pigment such as precipitated calcium carbonate, heavy calcium carbonate, kaolin, clay, talc, calcium sulfate, barium sulfate, titanium dioxide, zinc oxide, zinc sulfide, zinc carbonate, satin white, aluminum silicate, diatomaceous earth, calcium silicate, magnesium silicate, synthetic silica, aluminum hydroxide, alumina, lithophone, zeolite, magnesium carbonate, or magnesium hydrate; and an organic pigment such as styrene plastic pigment, acrylic plastic pigment, polyethylene, microcapsule, urea resin, or melamine resin. These may be used alone or in combination.

As an internal sizing agent used when producing the base, a neutral rosin size used for neutral papermaking, alkenyl succinic anhydride (ASA), alkyl ketene dimer (AKD), or a petroleum resin size may be used. Especially, a neutral rosin size and alkenyl succinic anhydride are preferable. Alkyl ketene dimer has a high sizing effect and therefore provides an enough sizing effect with a small amount. However, since alkyl ketene dimer reduces the friction coefficient of the surface of recording paper (medium), recording paper made using alkyl ketene dimer may cause a slip when being conveyed in an ink jet recording apparatus.

The thickness of the base is not particularly limited and may be suitably selected in accordance with the intended use. It is, however, preferably 50 μm to 300 μm. The basis weight of the base is preferably 45 g/m² to 290 g/m².

The coating layer may comprise a (white) pigment, a binder and may further contain a surfactant and other components as required.

An inorganic pigment or a combination of an inorganic pigment and an organic pigment can be used as the pigment.

Examples of the inorganic pigment include kaolin, talc, calcium bicarbonate, light calcium carbonate, calcium sulfite, amorphous silica, titanium white, magnesium carbonate, titanium dioxide, aluminum hydroxide, calcium hydroxide, magnesium hydroxide, zinc hydroxide and chlorite. Among these, kaolin is particularly preferable due to its superior glossability. The addition amount of the kaolin is preferably 50 parts by mass or more with respect to 100 parts of the binder in the coating layer.

When the amount of kaolin is less than 50 parts by mass, adequate effects are unable to be obtained with respect to glossiness.

Examples of the organic pigment include (aqueous) dispersions of, for example, styrene-acrylic copolymer particles, styrene-butadiene copolymer particles, polystyrene particles or polyethylene particles. These organic pigments may be used in combination.

The addition amount of the organic pigment is preferably 2 parts by mass to 20 parts by mass with respect to 100 parts by mass of the total amount of the pigment in the coating layer. Since the organic pigment has superior glossability and the specific gravity thereof is small in comparison with inorganic pigment, it allows the obtaining of a coating layer having high bulk, high gloss and satisfactory surface coatability.

An aqueous resin is preferably used for the binder. At least one of a water-soluble resin and a water-dispersible resin is preferably used for the aqueous resin. There are no particular limitations on the water-soluble resin, the water-soluble resin can be suitably selected according to the intended use.

Examples thereof include polyvinyl alcohol and polyvinyl alcohol modification products such as anion-modified polyvinyl alcohol, cation-modified polyvinyl alcohol or acetal-modified polyvinyl alcohol; polyurethane; polyvinyl pyrrolidone and polyvinyl pyrrolidone modification products such as copolymers of polyvinyl pyrrolidone and vinyl acetate, copolymers of vinyl pyrrolidone and dimethylaminoethyl methacrylate, copolymers of quaternized vinyl pyrrolidone and dimethylaminoethyl methacrylate or copolymers of vinyl pyrrolidone and methacrylamide propyl trimethyl ammonium chloride; celluloses such as carboxymethyl cellulose, hydroxyethyl cellulose or hydroxypropyl cellulose; cellulose modification products such as cationized hydroxyethyl cellulose; synthetic resins such as polyester, polyacrylic acid (ester), melamine resin or modification products thereof or copolymers of polyester and polyurethane; and poly(meth)acrylic acid, poly(meth)acrylamide, oxidized starch, phosphoric acid-esterified starch, self-modifying starch, cationized starch, various types of modified starch, polyethylene oxide, sodium polyacrylate and sodium arginate. These water-soluble resins may be used alone or in combination.

There are no particular limitations on the water-dispersible resin, a water-dispersible resin can be suitably selected in accordance with the intended use, and examples thereof include polyvinyl acetate, ethylene-vinyl acetate copolymers, polystyrene, styrene-(meth)acrylic acid ester copolymers, (meth)acrylic acid ester copolymers, vinyl acetate-(meth)acrylic acid (ester) copolymers, styrene-butadiene copolymers, ethylene-propylene copolymers, polyvinyl ether and silicone-acrylic copolymers. In addition, a crosslinking agent such as methylolated melamine, methylolated urea, methylolated hydroxypropylene urea or isocyanate may also be contained, and the water-dispersible resin may self-crosslink with a copolymer containing a unit such as N-methylolacrylamide. A plurality of these aqueous resins can also be used simultaneously.

The addition amount of the aqueous resin is preferably 2 parts by mass to 100 parts by mass and more preferably 3 parts by mass to 50 parts by mass with respect to 100 parts by mass of the pigment. The amount of the aqueous resin is determined so that the liquid absorption properties of the recording media are within a desired range.

### Printing Process

A printing process in which the inks according to the present invention may be suitably used is described with reference to the appended drawing shown in FIG. 1

FIG. 1 shows that a sheet of a receiving medium, in particular a machine coated or offset coated medium, P, is transported in a direction for conveyance as indicated by arrows and with the aid of transportation mechanism 12. Transportation mechanism 12 may be a driven belt system comprising one (as shown in FIG. 1) or more belts. Alternatively, one or more of these belts may be exchanged for one or more drums. A transportation mechanism may be suitably configured depending on the requirements (e.g. sheet registration accuracy) of the sheet transportation in each step of the printing process and may hence comprise one or more driven belts and/or one or more drums. For a proper conveyance of the sheets of receiving medium, the sheets need to be fixed to the transportation mechanism. The way of fixation is not particularly limited and may be selected from electrostatic fixation, mechanical fixation (e.g. clamping) and vacuum fixation. Of these vacuum fixation is preferred.

The printing process as described below comprises of the following steps: media pre-treatment, image formation, drying and fixing and optionally post treatment.

### Media Pre-Treatment

To improve the spreading and pinning (i.e. fixation of pigments and water-dispersed polymer particles) of the ink on the receiving medium, in particular on slow absorbing media, such as machine coated or offset coated media, the receiving medium may be pretreated, i.e. treated prior to printing an image on the medium. The pre-treatment step may comprise one or more of the following:
preheating of the receiving medium to enhance spreading of the used ink on the receiving medium and/or to enhance absorption of the used ink into the receiving medium;
primer pre-treatment for increasing the surface tension of receiving medium in order to improve the wettability of the receiving medium by the used ink and to control the stability of the dispersed solid fraction of the ink composition (i.e. pigments and dispersed polymer particles). Primer pre-treatment may be performed in the gas phase, e.g. with gaseous acids such as hydrochloric acid, sulfuric acid, acetic acid, phosphoric acid and lactic acid, or in the liquid phase by coating the receiving medium with a pre-treatment liquid. The pre-treatment liquid may comprise water as a solvent, one or more cosolvents, additives such as surfactants and at least one compound selected from a polyvalent metal salt, an acid and a cationic resin (discussed in detail above);
corona or plasma treatment.

### Primer Pre-Treatment

As an application way of the pre-treatment liquid, any conventionally known methods can be used. Specific examples of an application way include: a roller coating, an ink-jet application, a curtain coating and a spray coating.

In the context of the present invention, no primer application is performed but instead a method of printing an ink composition on receiving media comprising a water insoluble salt preferably comprising a polyvalent cation provides an in-situ primer formation. This means that where the ink is printed, the polyvalent cations are liberated from the receiving medium and act a coagulation/crashing agent for dispersed particles (e.g. pigments and/or latex resin particles).

### Corona or Plasma Treatment

Corona or plasma treatment may be used as a pre-treatment step by exposing a sheet of a receiving medium to corona discharge or plasma treatment. In particular when used on media like polyethylene (PE) films, polypropylene (PP) films, polyethylene terephthalate (PET) films and machine coated or offset coated media, the adhesion and spreading of the ink can be improved by increasing the surface energy of the media. With machine coated or offset coated media, the absorption of water and spreading can be promoted which may induce faster fixation of the image and less puddling on the receiving medium. Surface properties of the receiving medium may be tuned by using different gases or gas mixtures as medium in the corona or plasma treatment. Examples are air, oxygen, nitrogen, carbon dioxide, methane, fluorine gas, argon, neon and mixtures thereof. By pre-treating a receiving medium with a plasma, encapsulations (with e.g. dispersant and/or sizing agent) of the water insoluble salt present in the receiving medium can be etched away. Liberation of the water insoluble salt by the printing ink may thus be enhanced.

FIG. 1 shows that the sheet of receiving medium P may be conveyed to and passed through a first pre-treatment module 13, which module may comprise a preheater, for example a radiation heater, a corona/plasma treatment unit, a gaseous acid treatment unit or a combination of any of the above.

### Image Formation

Image formation is performed in such a manner that, employing an inkjet printer loaded with inkjet inks, ink droplets are ejected from the inkjet heads based on the digital signals onto a print medium.

Although both single pass inkjet printing and multi pass (i.e. scanning) inkjet printing may be used for image formation, single pass inkjet printing is preferably used since it is effective to perform high-speed printing. Single pass inkjet printing is an inkjet recording method with which ink droplets are deposited onto the receiving medium to form all pixels of the image by a single passage of a receiving medium underneath an inkjet marking module.

In FIG. 1, 11 represents an inkjet marking module comprising four inkjet marking devices, indicated with 111, 112, 113 and 114, each arranged to eject an ink of a different color (e.g. Cyan, Magenta, Yellow and Black). The nozzle pitch of each head is e.g. about 360 dpi. In the present invention, “dpi” indicates a dot number per 2.54 cm.

An inkjet marking device for use in single pass inkjet printing, 111, 112, 113, 114, has a length of at least the width of the desired printing range, the printing range being perpendicular to the media transport direction, indicated with arrows. The inkjet marking device may comprise a single printhead having a length of at least the width of said desired printing range. The inkjet marking device may also be constructed by combining two or more inkjet heads, such that the combined lengths of the individual inkjet heads cover the entire width of the printing range. Such a constructed inkjet marking device is also termed a page wide array (PWA) of print heads.

In image formation by ejecting an ink, an inkjet head (i.e. printhead) employed may be either an on-demand type or a continuous type inkjet head. As an ink ejection system, there may be usable either the electric-mechanical conversion system (e.g., a single-cavity type, a double-cavity type, a bender type, a piston type, a shear mode type, or a shared wall type), or an electric-thermal conversion system (e.g., a thermal inkjet type, or a Bubble Jet type (registered trade name)). Among them, it is preferable to use a piezo type inkjet recording head which has nozzles of a diameter of 30 μm or less in the current image forming method.

FIG. 1 shows that after pre-treatment, the receiving medium P is conveyed to upstream part of the inkjet marking module 11. Then, image formation is carried out by each color ink ejecting from each inkjet marking device 111, 112, 113 and 114 arranged so that the whole width of the receiving medium P is covered.

Optionally, the image formation may be carried out while the receiving medium is temperature controlled. For this purpose a temperature control device 19 may be arranged to control the temperature of the surface of the transportation mechanism (e.g. belt or drum) underneath the inkjet marking module 11. The temperature control device 19 may be used to control the surface temperature of the receiving medium P, for example in the range of 30° C. to 60° C. The temperature control device 19 may comprise heaters, such as radiation heaters, and a cooling means, for example a cold blast, in order to control the surface temperature of the receiving medium within said range. Subsequently and while printing, the receiving medium P is conveyed to the downstream part of the inkjet marking module 11.

### Drying and Fixing

After an image has been formed on the receiving medium, the prints have to be dried and the image has to be fixed onto the receiving medium. Drying comprises the evaporation of solvents, in particular those solvents that have poor absorption characteristics with respect to the selected receiving medium.

FIG. 1 may have a drying and fixing unit, which may comprise a heater, for example a radiation heater. After an image has been formed, the print is conveyed to and passed through the drying and fixing unit. The print is heated such that solvents present in the printed image, to a large extent water, evaporate. The speed of evaporation and hence drying may be enhanced by increasing the air refresh rate in the drying and fixing unit. Simultaneously, film formation of the ink occurs, because the prints are heated to a temperature above the minimum film formation temperature (MFT). The residence time of the print in the drying and fixing unit and the temperature at which the drying and fixing unit operates are optimized, such that when the print leaves the drying and fixing unit a dry and robust print has been obtained. As described above, the transportation mechanism 12 in the fixing and drying unit may be separated from the transportation mechanism of the pre-treatment and printing section of the printing apparatus and may comprise a belt or a drum.

Hitherto, the printing process was described such that the image formation step was performed in-line with the pre-treatment step (e.g. application of an (aqueous) pre-treatment liquid) and a drying and fixing step, all performed by the same apparatus (see FIG. 1). However, the printing process is not restricted to the above-mentioned embodiment. A method in which two or more machines are connected through a belt conveyor, drum conveyor or a roller, and the step of applying an aqueous pre-treatment liquid, the (optional) step of drying a coating solution, the step of ejecting an inkjet ink to form an image and the step or drying an fixing the printed image are performed. It is, however, preferable to carry out image formation with the above defined in-line image forming method.

### EXAMPLES

### Materials

All materials used in the examples are used as obtained from the supplier, unless otherwise stated.

Latices from the Neocryl® product line (i.e. BT-9, BT-21, BT-24, BT-107s, A662, A633 and XK39 are obtained from DSM.

Solthix® a100 is an alkali swellable acrylic emulsion, Carbojet® is an alkali soluble acrylic copolymer emulsion, both obtained from Lubrizol, Ltd.

The used pigments are of the Cab-o-jet® product-line and obtained from Cabot Corporation.

The used surfactants are of the Tegowet® product-line and obtained from Evonik.

Ammonium alginate is obtained from KIMICA Corporation.

Glycerin (glycerol) and 1,3 butanediol are obtained from Sigma Aldrich.

Vantex®-T is used as a pH modifier and is obtained from Taminco.

The receiving media used in the Examples are listed in Table 1.

TABLE 1
Receiving media

| No. | Receiving medium | gr/m² | Supplier |
|---|---|---|---|
| 1 | Top Coated Pro Silk ® | 115 | Océ |
| 2 | Top Coated Pro Gloss ® | 115 | Océ |
| 3 | Hello Matt ® | 115 | Magno Star produced by |
| | | | Sappi |
| 4 | Digifinesse gloss ® | 115 | UPM |
| 5 | Hello Gloss ® | 300 | Magno Star produced by |
| | | | Sappi |
| 6 | Hello Gloss ® | 155 | Magno Star produced by |
| | | | Sappi |
| 7 | Top Coated Plus Gloss ® | 155 | Océ |
| 8 | Top Coated Plus Silk ® | 155 | Océ |

### Measurement Techniques

### pH Measurement

The pH was measured with Voltcraft pH100 ATC apparatus (Conrad Electronics), using a calomel electrode. The apparatus was first calibrated with pH 7 and pH 10 buffer solutions.

### Gelling Property of the Ink

### Viscosity

The viscosity is measured using a Haake Rheometer, type Haake Rheostress RS 600, with a flat plate geometry at a temperature of 25° C. unless otherwise indicated. The viscosity is measured at shear rates (\dot{γ}) in the range of between 10 s⁻¹ and 1000 s⁻¹, unless otherwise indicated. The viscosity as a function of shear rate is determined, from which X² is determined. The X² parameter is a measure for the deviation from Newtonian behavior, e.g. a X² of above 1 indicates gelling of the ink composition.

In case the viscosity of a liquid applied to a substrate is determined, the substrate is mounted and fixed on the bottom plate of the rheometer and the top plate is placed at 0.5 mm distance (i.e. 0.5 mm gap), unless otherwise stated.

### Vertical Flow Test

Droplets having a volume of approximately 2 μl are applied to a vertically arranged print substrate (approximately 90°) with a 10 μl syringe. The droplets are allowed to freely run under the influence of gravity forces. The length of the final dot or line is measured (mm) and used as an indication of the thickening of the ink composition.

### Plasma Treatment

Plasma treatment of printing substrates was performed with a nitrogen plasma, using a plasma unit obtained from Softal. The plasma unit comprises 3 high voltage electrodes having a length of 350 mm and arranged at a distance in the range of 0.5 and 1.5 mm with respect to the ground electrode, depending on the type of gas used. For a nitrogen plasma the optimal distance between the high voltage electrodes and the ground electrode is between 0.9 and 1.2 mm. Plasma dosages in a range of 0-600 Wmin/m² are applied to the printing substrates.

### Experiment 1: Preparation of Acidic Latex Ink Composition

18.87 grams of NeoCryl® BT-107s, 26.42 grams of Cab-O-Jet® 250c pigment dispersion, 27.36 grams of 1,3 butanediol (obtained from Sigma Aldrich) and 27.36 grams of demineralized water were mixed in a vessel, stirred for approximately 60 minutes and filtered over a Pall Profile Star absolute glass filter having a pore size of 1 μm.

The obtained ink composition comprises:
8.5 weight % NeoCryl® 107s latex (amount of solids relative to the total ink composition);
4 weight % Cab-O-Jet® 250c pigment (amount of solids relative to the total ink composition);
27.4 weight % 1,3 butanediol; and
60.2 weight % water.

The initial pH of the ink composition was 2.6. The initial viscosity of the ink composition was 3.44 mPa*s. The initial X² parameter was 0.00196.

### Example 1

### Dependency of Viscosity and X² Parameter of the pH

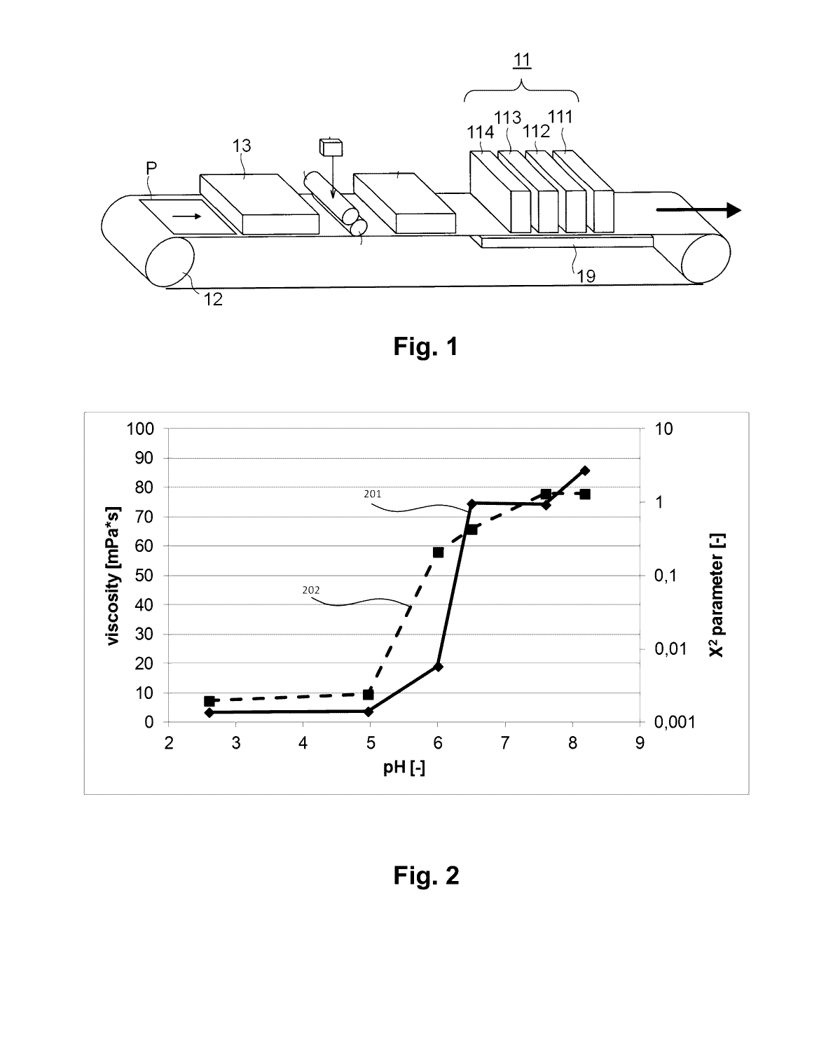

The pH of the ink composition according to experiment 1 was tuned by adding Vantex®-T, such that the pH varied in a range of 2.6 (initial pH) to approximately 8. The viscosity and X² parameter were determined in the above defined pH-range in accordance with the method described above. The results are shown in FIG. 2.

FIG. 2. shows that both the viscosity (curve 201) and the X²-parameter (curve 202) of the ink composition in accordance with Experiment 1 starts to increase at a pH of around 5. The viscosity increases from 3.4 at a pH of 2.6 to 85.9 at a pH of 8.2. The X² parameter increases from 0.002 to 1.3, indicating that the ink composition starts deviating from Newtonian behavior due to increase of the pH. The latter indicates that unsheared ink (e.g. an ink droplet on a printing substrate) may gel with increasing pH.

### Example 2

### Influence of Ca²⁺ Concentration on Viscosity and X² Parameter

Calcium ions were added to the ink composition according to experiment 1, by adding Ca(NO₃)₂.6H₂O to the ink composition. The viscosity and X² parameter were determined as a function of Calcium concentration in accordance with the method described above. The results are shown in FIG. 3.

FIG. 3 shows that both the viscosity (curve 301) and the X² parameter (curve 302) increase with increasing calcium concentration (shown in arbitrary units).

### Example 3

### Viscosity of Acidic Ink Composition on Printing Substrate as a Function of Time

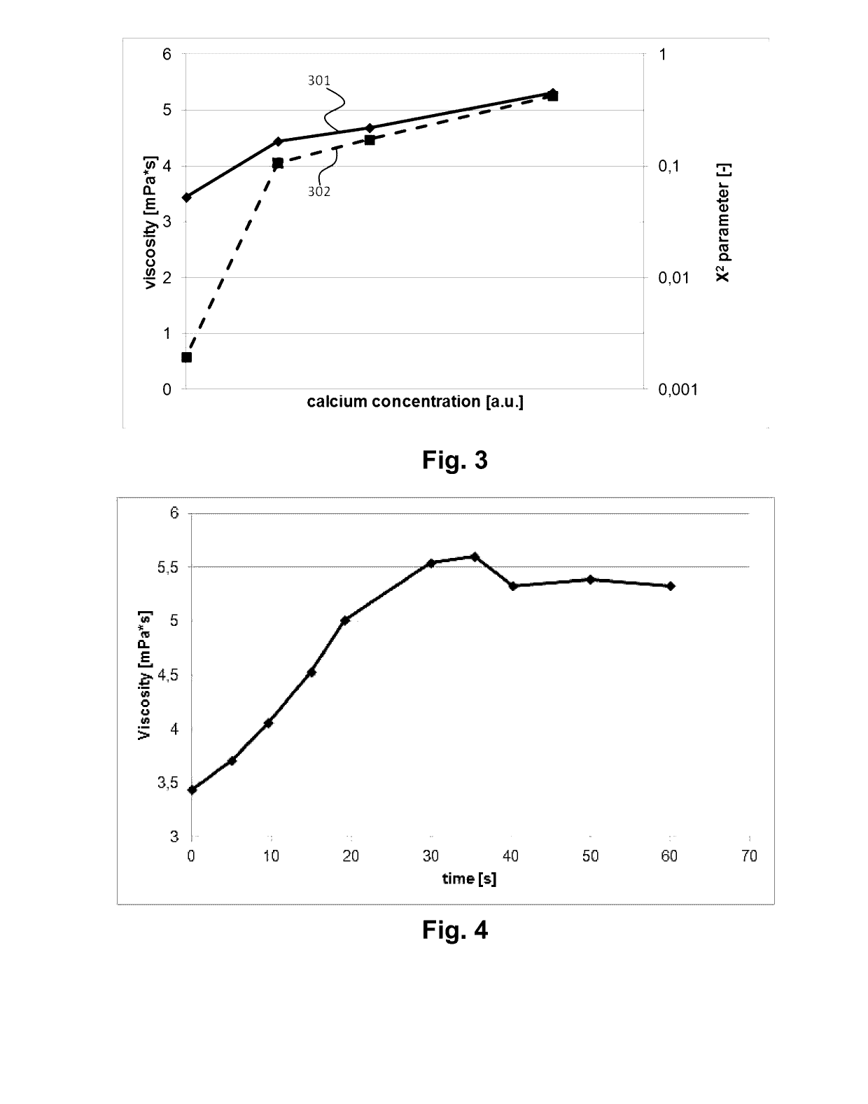

A layer of the ink composition according to Experiment 1 was coated on a Hello Gloss® 250 g/m² printing substrate and the viscosity at constant shear of the ink composition on the printing substrate was determined as a function of time in accordance with the above described method. The results are shown in FIG. 4.

FIG. 4 shows that the viscosity of the ink composition increases with time. In a time frame of about 30 seconds, the viscosity has reached the same level as the observed viscosity increase by adding 0.2 mol Ca²⁺ ions (see FIG. 3.). However, in this experiment the viscosity increase may be a combined effect of water absorption into the printing substrate (which is a minor effect due to the selection of a low absorbing printing substrate), neutralization of the ink composition (see FIG. 2.) and solubilization of the Ca²⁺ ions present in the printing substrate (as CaCO₃). From FIG. 3 it can be concluded that also the X² parameter will increase due to Ca²⁺ solubilization. Therefore, the ink composition will attain non-Newtonian behavior. This means that ink droplets that have landed on the surface of the printing substrate will show an increase in viscosity and show non-Newtonian behavior. The latter may result in gelling of the ink of the undisturbed (i.e. no shear) in droplets on the printing substrate.

Therefore, it can be concluded that acidic ink compositions are capable of in-situ primer formation. The liberated Ca²⁺ ions are capable of pinning the dispersed colorant to the printing substrate (normal primer function) and are also capable of gelling the ink composition.

### Experiments 2-13: Preparation of Acidic Latex Ink Composition

Several acidic ink compositions have been prepared in accordance with the preparation method described in Experiment 1.

In Experiment 13, ammonium alginate was added as an additional gelling agent.

The compositions of the respective ink compositions, the initial pH, initial viscosity and the initial X² parameter are shown in Table 2.

The pH after adding Vantex®-T to the ink compositions, the viscosity and X² parameter at that pH are also shown in Table 2.

### Comparative Experiments A and B Preparation of Alkaline Ink Compositions

Experiment 2 was repeated with NeoCryl® A-622 as a latex in the ink composition. Composition, pH and rheological data of these ink compositions are shown in Table 2. For Comparative Experiment B, NeoCryl® A-633 was used as a latex composition.

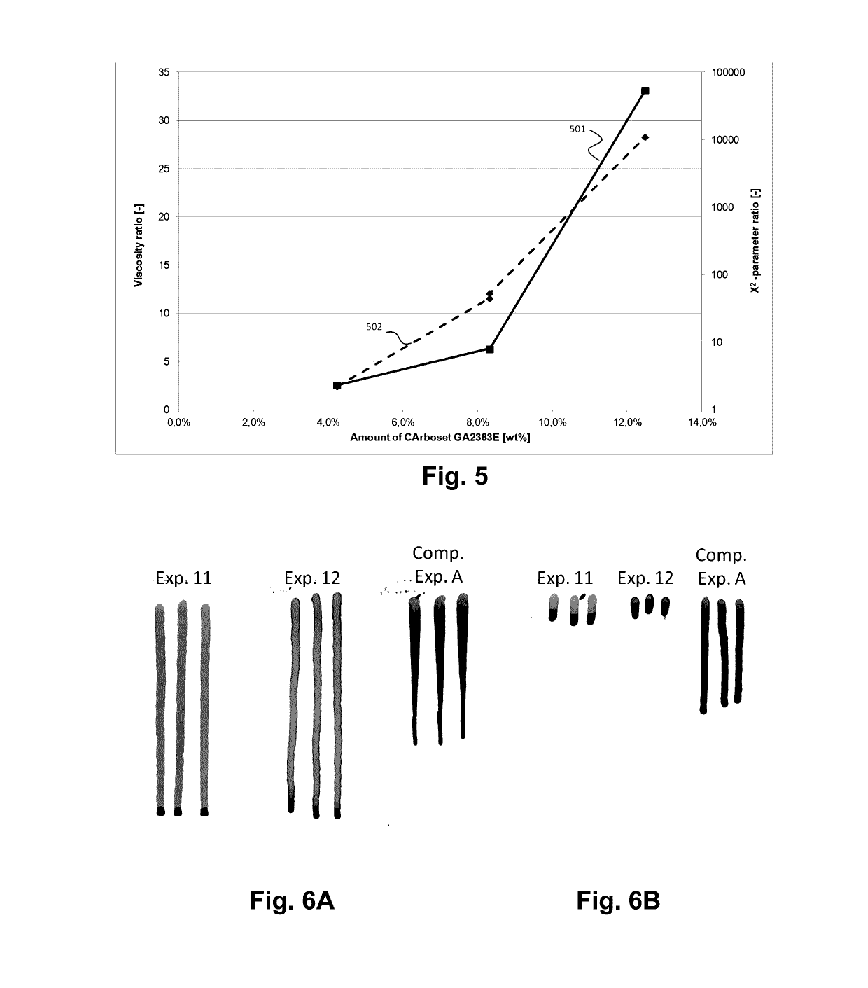

Table 2 shows that the rheological behavior of the acidic ink recipes can be tuned by the amount of alkali swellable or soluble latex composition, see Experiments 2-5 and FIG. 5. FIG. 5 shows that the ratio of the viscosity (i.e. viscosity at high pH/viscosity at low pH) increases with increasing concentration of Carboset® GA2363E (curve 501). FIG. 5 also shows that the ratio of the X²-parameter (i.e. X² at high pH/X² at low pH) also increases with increasing concentration of Carboset® GA2363E (curve 502). It can therefore be concluded that the concentration of the alkali swellable or soluble latex can be used to tune the rheological behavior and the dependency of pH thereof.

Table 2 further shows (Experiments) that a complete CMYK ink set can be manufactured, comprising acidic inks having properties as used in a printing method according to the present invention, see experiments 5-8.

Experiment 9 shows that only a small amount of a specific alkali swellable or soluble latex (i.e. Solthix® a100) is required to obtain a substantial rheological change as a function of pH.

TABLE 2
Compositions and properties of ink compositions according to Experiments 2-13 and Comparative Experiments A and B

| | Exp. 2 | Exp. 3 | Exp. 4 | Exp. 5 | Exp. 6 | Exp. 7 | Exp. 8 |
|---|---|---|---|---|---|---|---|
| Components [wt %] | | | | | | | |
| CArboset GA2363E | 4.2% | 8.3% | 8.3% | 12.5% | 12.5% | 12.5% | 12.5% |
| solthix ™ a100 | | | | | | | |
| NeoCryl ® BT-9 | | | | | | | |
| NeoCryl ® BT-21 | | | | | | | |
| NeoCryl ® A-662 | | | | | | | |
| NeoCryl ® A-633 | | | | | | | |
| Cab-O-Jet ® 250-C | 1.1% | 1.1% | 1.1% | 1.1% | | | |
| Cab-O-Jet ® 260-M | | | | | 1.1% | | |
| Cab-O-Jet ® 270-Y | | | | | | 1.1% | |
| Cab-O-Jet ® 200 black | | | | | | | 1.1% |
| glycerin | 16.2% | 17.7% | 26.5% | 26.5% | 26.5% | 26.5% | 26.5% |
| NH₄-alginaat | | | | | | | |
| Tegowet ® 510 | 0.9% | 0.9% | 0.9% | 0.9% | 0.9% | 0.9% | 0.9% |
| Tegowet ® 240 | | | | | | | |
| balance water (to 100 wt %) | 77.6% | 72.0% | 63.2% | 59.0% | 59.0% | 59.0% | 59.0% |
| Properties | | | | | | | |
| initial pH [—] | 4.5 | 4.3 | 4.2 | 3.9 | 3.9 | 3.9 | 3.9 |
| initial viscosity [mPa * s] | 1.738 | 2.112 | 2.677 | 3.659 | 3.704 | 3.84 | 4.097 |
| initial X²-parameter | 0.00056 | 0.00037 | 0.00018 | 0.00139 | 0.00041 | 0.00018 | 0.00101 |
| pH after addition of Vantex ®-T | 8.5 | 8.5 | 8.5 | 8.5 | 8.5 | 8.5 | 8.5 |
| vicosity after addition of Vantex ®-T [mPas] | 4.417 | 13.4 | 16.82 | 121.3 | 115.8 | 135.6 | 118 |
| X² parameter after addition of Vantex ®-T | 0.00124 | 0.0165 | 0.00956 | 15.3 | 9.751 | 26.93 | 0.09048 |

| | | | | | | Comp. | Comp. |
|---|---|---|---|---|---|---|---|
| | Exp. 9 | Exp. 10 | Exp. 11 | Exp. 12 | Exp. 13 | Exp. A | Exp. B |
| Components [wt %] | | | | | | | |
| CArboset GA2363E | | | | 9.1% | | | |
| solthix ™ a100 | 0.2% | | | | | | |
| NeoCryl ® BT-9 | | | 7.8% | | | | |
| NeoCryl ® BT-21 | | 13.9% | | | 7.7% | | |
| NeoCryl ® A-662 | | | | | | 7.8% | |
| NeoCryl ® A-633 | | | | | | | 7.80% |
| Cab-O-Jet ® 250-C | 1.6% | 1.2% | 1.8% | 1.8% | 1.8% | 1.8% | 1.8% |
| Cab-O-Jet ® 260-M | | | | | | | |
| Cab-O-Jet ® 270-Y | | | | | | | |
| Cab-O-Jet ® 200 black | | | | | | | |
| glycerin | 34.9% | 26.0% | 17.6% | 17.6% | 17.6% | 17.6% | 17.60% |
| NH₄-alginaat | | | | | 0.1% | | |
| Tegowet ® 510 | | | | | | | |
| Tegowet ® 240 | 1.7% | 1.3% | 1.3% | 1.3% | 1.3% | 1.3% | 1.30% |
| balance water (to 100 wt %) | 61.6% | 57.7% | 71.5% | 70.2% | 71.5% | 71.5% | 71.5% |
| Properties | | | | | | | |
| initial pH [—] | 5.5 | 3.5 | 4 | 4.5 | 3.9 | 8.8 | n.d. |
| initial viscosity [mPa * s] | 4.746 | 4.908 | 2.267 | 2.255 | 5.744 | 2.932 | n.d. |
| initial X²-parameter | 0.01 | 0.0053 | 0.00062 | 0.00064 | 0.00573 | 0.00036 | n.d. |
| pH after addition of Vantex ®-T | 9 | 8.5 | 8.7 | 8.7 | n.d. | n.d. | n.d. |
| vicosity after addition of Vantex ®-T [mPas] | 30.01 | 29.62 | 4.546 | 21.29 | n.d. | n.d. | n.d. |
| X² parameter after addition of Vantex ®-T | 249 | 0.8592 | 0.00822 | 0.01789 | n.d. | n.d. | n.d. |

n.d. = not determined

### Example 2

### Vertical Flow Test of Ink Compositions According to Experiments 10-13 and Comparative Experiment A

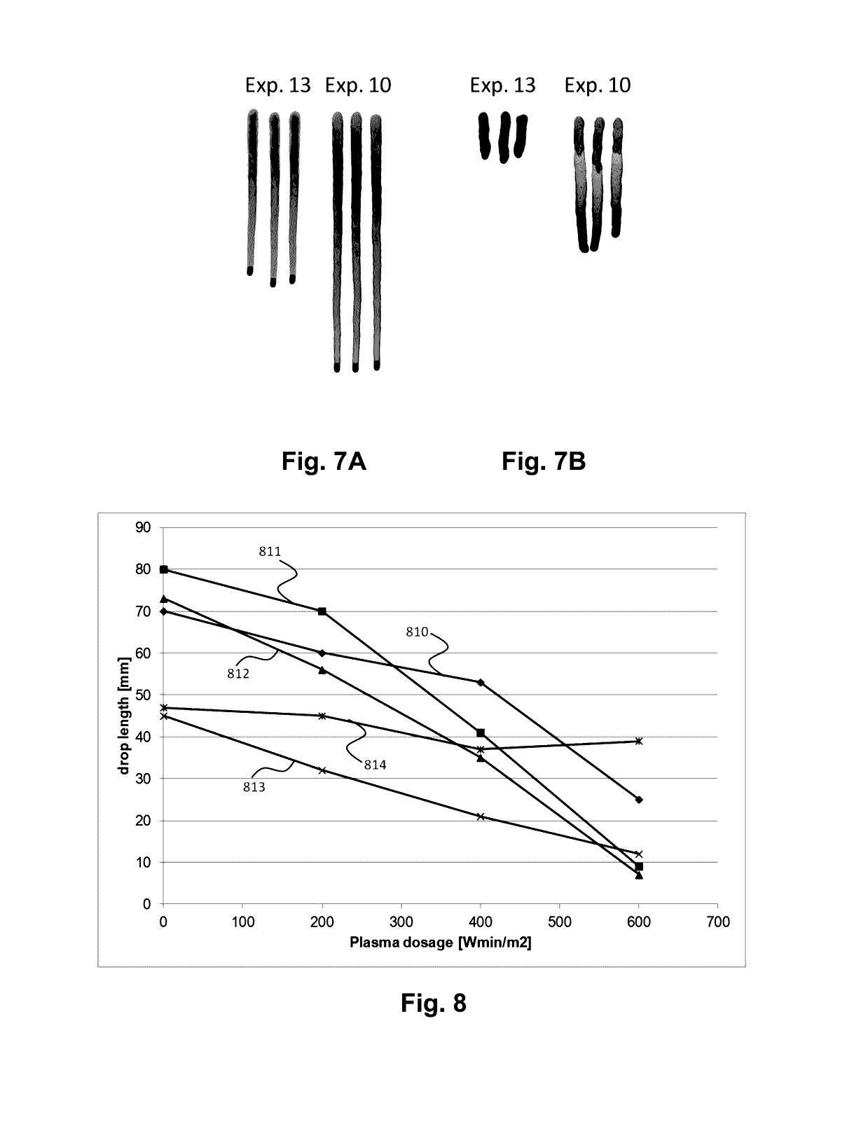

Droplets having a volume of approximately 2 μl of inks according to Experiments 10-13 and Comparative Experiment A were applied to printing substrate nr. 5 (Table 1) and the printing substrate was vertically arranged (approximately 90°), such that the ink droplets were allowed to sag. The length of the final dot or line was measured (mm) and used as an indication of the thickening of the ink composition. The results are shown in Table 3. The results are also shown in FIG. 6A for ink compositions according to experiments 11, 12 and comparative experiment A and in FIG. 7A for ink compositions according to experiments 10 and 13.

### Example 3

### Vertical Flow Test of Ink Compositions According to Experiments 10-13 and Comparative Experiment A on Plasma Treated Printing Substrates

Example 2 was repeated, with the difference that prior to applying an ink droplet onto the printing substrate, the substrate was treated with a nitrogen plasma in accordance with a method described above at plasma dosages of 200 Wmin/m², 400 Wmin/m² and 600 Wmin/m², respectively. Results are shown in Table 3 and FIG. 8. FIGS. 6B and 7B show the results of the vertical flow tests after nitrogen plasma treatment with a dosage of 600 Wmin/m², respectively.

TABLE 3
results of vertical flow tests Examples 2 and 3

| Plasma | drop lengths [mm] | | | | |
|---|---|---|---|---|---|
| dosage | | | | | Comp. |
| [Wmin/m²] | Exp. 10 | Exp. 11 | Exp. 12 | Exp. 13 | Exp. A |
| Curve in | 810 | 811 | 812 | 813 | 814 |
| FIG. 8 | | | | | |
| 0 | 70 | 80 | 73 | 45 | 47 |
| 200 | 60 | 70 | 56 | 32 | 45 |
| 400 | 53 | 41 | 35 | 21 | 37 |
| 600 | 25 | 9 | 7 | 12 | 39 |

FIG. 6A shows that acidic ink compositions according to experiments 11 and 12 show longer running lines that the alkaline ink composition according to comparative experiment A. This may be explained by the lower initial viscosity of the ink compositions according to experiments 11 and 12 compared to the ink composition according to comparative experiment A (see Table 2). However, as shown in FIG. 6B, when the print substrate is plasma treated prior to applying the ink droplets, the inks according to experiments 11 and 12 show significantly shorter lines compared to the ink composition according to comparative experiment A. Without wanting to be bound to any theory, it is thought that the nitrogen plasma treatment: 1) enhances the basic nature of the surface of the printing substrate and 2) provides more ‘free’ CaCO₃ on the surface of the printing substrate due to etching by the plasma treatment (i.e. Ca²⁺ ions are more easily liberated by the acidic ink composition). The first leads to a faster neutralization of the ink composition, the second to in-situ primer formation by liberation of Ca²⁺ ions by the acidic ink composition. Both effects lead to an increase of the viscosity and to gelling of the ink composition (see FIGS. 2 and 3) to an extent that is not observed for alkaline ink compositions.

FIG. 7A shows the results of the results of the vertical flow tests of two acidic ink compositions according to experiments 10 and 13. The ink composition according to experiment 10 has a lower initial viscosity and shows a longer running length than the ink composition according to experiment 13. FIG. 7B shows that the running lengths of both ink compositions at a printing substrate that has been treated with a nitrogen plasma at a plasma dosage of 600 Wmin/m² have decreased. The running length of the ink according to experiment 10 reduces to approximately half the length on untreated printing substrates and the running length of the ink according to experiment 13 is approximately a third of the running length on untreated printing substrates. Comparing the ink compositions (see Table 2), it is noted that the ink according to experiment 13 comprises less alkali swellable/soluble resin dispersion. Therefore, pH induced gelling (see also FIG. 2) due to neutralization of the ink composition is expected to be lower for the ink composition according to experiment 13. Without wanting to be bound to any theory, it is believed that the ink composition according to example 13, which comprises ammonium alginate as a gelling agent, also shows calcium induced gelling (see FIG. 3), which is more pronounced when the printing substrates are plasma treated.

FIG. 8 shows that the influence of plasma treatment on the drop length of acidic ink compositions (curves 810, 811, 812 and 813) is more pronounced than the influence of plasma treatment on drop length of an alkaline ink composition (curve 814). Without wanting to be bound to any theory, it is thought this effect is caused by two phenomena:
1) the basic nature of the surface of the printing substrate is enhanced by plasma etching with a nitrogen plasma. Neutralization of the ink composition occurs more quickly, therefore gelling of the ink composition due to pH switch occurs (see also FIG. 2). This effect does not occur with an alkaline ink composition; and
2) due to plasma etching, more Ca²⁺ is liberated at the surface of the print substrate and more easily accessible to the ink composition. Acidic ink compositions are better able to dissolve the liberated cations than alkaline ink compositions. Ca²⁺ induced gelling occurs (see also FIG. 2). Calcium induced gelling can be enhanced by adding an alginate (see curve 813, ink according to example 13).

### Example 4

Examples 2 and 3 were repeated for ink compositions according to experiment 13 and comparative experiment B on media 1-8 of Table 1. The plasma treatment was performed at a plasma dosage of 75 Wmin/m². The results are shown in Table 4.

From Table 4 it can be concluded that even at a plasma treatment with a dosage of 75 Wmin/m², the gelling effect is more enhanced for the acidic ink composition (ratio >1) when compared to the alkaline ink composition, at least for all printing substrates listed in Table 1.

In general it can be concluded that acidic ink compositions are capable of liberating multivalent cations (in particular Ca²⁺) present as water insoluble components in printing substrates. The liberated cations may trigger cation sensitive processes in the ink composition, such as pinning of pigments and/or gelling of the ink composition. Furthermore, the liberation of multivalent cations from printing substrates can be enhanced by plasma etching.

TABLE 4
results of Example 4

| | Plasma | | |
|---|---|---|---|
| Receiving | treatment | | Comp. |
| medium | (yes/no) | Exp 1 | Exp. B |
| 1 | no | 49 | 31 |
| | yes | 28 | 25 |
| | ratio¹⁾ | 1.75 | 1.24 |
| 2 | no | 38 | 27 |
| | yes | 28 | 27 |
| | ratio¹⁾ | 1.36 | 1 |
| 3 | no | 47 | 34 |
| | yes | 37 | 28 |
| | ratio¹⁾ | 1.27 | 1.21 |
| 4 | no | 38 | 28 |
| | yes | 32 | 31 |
| | ratio¹⁾ | 1.19 | 0.90 |
| 5 | no | 70 | 39 |
| | yes | 48 | 40 |
| | ratio¹⁾ | 1.46 | 0.98 |
| 6 | no | 51 | 38 |
| | yes | 41 | 32 |
| | ratio¹⁾ | 1.24 | 1.19 |
| 7 | no | 44 | 31 |
| | yes | 38 | 31 |
| | ratio¹⁾ | 1.16 | 1 |
| 8 | no | 51 | 29 |
| | yes | 36 | 31 |
| | ratio¹⁾ | 1.42 | 0.94 |

¹⁾ratio line length untreaded/plasma treated

Although specific embodiments of the invention are illustrated and described herein, it will be appreciated by those of ordinary skill in the art that a variety of alternate and/or equivalent implementations exist. It should be appreciated that the exemplary embodiment or exemplary embodiments are examples only, and are not intended to limit the scope, applicability, or configuration in any way. Rather, the foregoing summary and detailed description will provide those skilled in the art with a convenient road map for implementing at least one exemplary embodiment, it being understood that various changes may be made in the function and arrangement of elements described in an exemplary embodiment without departing from the scope as set forth in the appended claims and their legal equivalents. Generally, this application is intended to cover any adaptations or variations of the specific embodiments discussed herein.

1. A method of printing comprising the steps of:
providing a recording substrate comprising a water insoluble salt comprising a polyvalent cation;
providing an aqueous ink composition comprising stably dispersed particles, the pH of the ink composition being between 2 and 5.5;
printing the aqueous ink composition on the recording substrate.

2. The method according to claim 1, comprising the additional step of:
treating a first surface of the recording substrate with a plasma prior to printing the aqueous ink on the recording substrate, wherein the aqueous ink is printed on the first surface of the recording substrate.

3. The method according to claim 2, wherein the plasma is a nitrogen plasma.

4. The method according to claim 2, wherein the first surface of the recording substrate is treated with a plasma power of between 10 and 1000 Wmin/m².

5. The method according to claim 1, wherein the water insoluble salt comprises a polyvalent metal ion.

6. The method according to claim 1, wherein the stably dispersed particles in the aqueous ink composition comprise dispersed resin particles and/or dispersed colorant particles.

7. The method according to claim 6, wherein the dispersed colorant particles are selected from the group consisting of particles of water insoluble dyes, water insoluble pigment particles and combinations thereof.

8. The method according to claim 6, wherein the dispersed resin particles comprise alkali swellable resin particles and/or alkali soluble resin particles.

9. The method according to claim 1, wherein the aqueous ink composition further comprises a gelling agent, the gelling agent having the property of gelling the aqueous ink composition when triggered by a cation.

10. The method according to claim 9, wherein the gelling agent is an ink soluble salt of alginic acid.

11. The method according to claim 10, wherein the salt of alginic acid comprises Na⁺, K⁺ or NH₄⁺ as cation.

12. The method according to claim 9, wherein the cation is a polyvalent metal ion.

13. The method according to claim 1, wherein the water insoluble salt is CaCO₃, and the aqueous ink composition comprises a pigment and alkaline swellable and/or soluble resin particles.

14. The method according to claim 13, wherein the aqueous ink composition further comprises a Na⁺, K⁺ or NH₄⁺ salt of alginic acid.

15. The method according to claim 1, wherein the ink composition is printed with an inkjet printing device.

16. The method according to claim 1, wherein no pre-treatment liquid application step is present prior to printing the aqueous ink composition on the recording substrate.

17. The method according to claim 1, wherein the water insoluble salt comprising a polyvalent cation present in the print substrate is encapsulated by a (polymeric) dispersant or sizing agent.
